(19) United States
(12) Patent Application Publication
(10) Pub. No.: US 2013/0230318 A1
(43) Pub. Date: Sep. 5, 2013

(54) COMMUNICATIONS INTERFACE APPARATUS AND METHOD OF OPERATING THE SAME

(71) Applicants: Eung Ju Kim, Suwon (KR); Won Jin Baek, Suwon (KR); Kyung Uk Kim, Suwon (KR)

(72) Inventors: Eung Ju Kim, Suwon (KR); Won Jin Baek, Suwon (KR); Kyung Uk Kim, Suwon (KR)

(73) Assignee: SAMSUNG ELECTRO-MECHANICS CO., LTD.

(21) Appl. No.: 13/533,729

(22) Filed: Jun. 26, 2012

(30) Foreign Application Priority Data
Mar. 5, 2012 (KR) 10-2012-0022377

(51) Int. Cl. H04B 10/12

(52) U.S. Cl. 398/43; 398/142

(57) ABSTRACT

There are provided a communications interface apparatus and a method of operating the same. The communications interface apparatus includes: a transmission line including a conductor line and a plastic optical fiber for optical communications; a signal transmitting unit transmitting a first data signal through the plastic optical fiber and transmitting a second data signal through the conductor line; and a signal receiving unit receiving the first data signal and the second data signal, wherein the signal transmitting unit differentiates a signal as the first data signal or the second data signal based on at least one of a level and a frequency of the signal to be transmitted.

### CROSS-REFERENCE TO RELATED APPLICATIONS

This application claims the priority of Korean Patent Application No. 10-2012-0022377 filed on Mar. 5, 2012, in the Korean Intellectual Property Office, the disclosure of which is incorporated herein by reference.

### BACKGROUND OF THE INVENTION

1. Field of the Invention

The present invention relates to an interface apparatus and a method of operating the same able to facilitate rapid and efficient data communications transmissions, of a display having a high degree of freedom in terms of hardware design.

2. Description of the Related Art

Display apparatuses applied to electronic devices such as mobile electronic devices and the like, are required to process composite signals, such as image data signals transmitted from a central processing unit (CPU) of an electronic device, power signals, touch sensing signals detected from a touch screen, signals sensed by an image sensor, or the like. To this end, a method of transmitting an 8 bit or larger signal through two differential lines by a low voltage differential signaling (LVDS) mechanism has been proposed. However, the above-mentioned method also requires a connection line for additional control.

Meanwhile, with regard to a mechanism for processing a high-speed, large-capacity data transmission between the display and the central processing unit (CPU) in a mobile device at low power, a mobile industry processor interface (MIPI) standard has been proposed. In the MIPI-compliant transmission mechanism, a transmission rate of 850 Mbps may be implemented through a single lane using a high speed (HS) mode and a low power (LP) mode, and a maximum bit rate of 3.2 Gbps may be supported, in particular, when using four lanes.

The MIPI-compliant transmission mechanism serializes pieces of data included in a signal output in parallel so as to comply with the MIPI standard, transmits the serialized data, and then, once more de-serializes the received data, thereby reconstituting the data to form an image. However, even when transmitting a signal including the large-capacity image data using the MIPI standard, the display device is connected to the CPU by a general conductor line (generally formed of copper) and as a result, design restrictions may be increased, while the occurrence of electromagnetic interference (EMI) and signal loss over distance may be increased.

In the following Patent Documents 1 and 2, Patent Document 1 relates to a method of controlling multi-level communications between a communications bus and devices, which discloses controlling a level of a plurality of signals having compatibility and transmitting and receiving the controlled signal, while Patent Document 2 relates to a display interface system, which discloses transmitting and receiving a data signal or a clock signal through a plurality of channels.

### RELATED ART DOCUMENTS

(Patent Document 1) U.S. Pat. No. 7,671,628
(Patent Document 2) Korean Patent Laid-Open Publication No. KR 10-2009-0107219

### SUMMARY OF THE INVENTION

An aspect of the present invention provides a communications interface apparatus and a method of operating the same, capable of reducing limitations on hardware design and significantly reducing signal loss over distance by transmitting a plurality of data signals having different levels or frequencies through a transmission line formed by combining a plastic optical fiber with a conductor line and transmitting high-capacity data through the plastic optical fiber.

According to an aspect of the present invention, there is provided a communications interface apparatus, including: a transmission line including a conductor line and a plastic optical fiber for optical communications; a signal transmitting unit transmitting a first data signal through the plastic optical fiber and transmitting a second data signal through the conductor line; and a signal receiving unit receiving the first data signal and the second data signal, wherein the signal transmitting unit differentiates a signal as the first data signal or the second data signal based on at least one of a level and a frequency of the signal to be transmitted.

The signal transmitting unit may include: a signal converting unit generating the first data signal by serializing original data provided in parallel and generating the second data signal transmitted in a low power mode from part of the data provided in parallel; and an optical output unit outputting the first data signal to the plastic optical fiber.

The signal converting unit may include: a repeater block filtering the original data; a serializer serializing an output of the repeater block; and a driving circuit unit generating the first data signal transmitted in a high speed mode from an output of the serializer.

The signal receiving unit may include: an optical signal detector receiving the first data signal from the plastic optical fiber; a de-serializer de-serializing the first data signal to realign a plurality of pieces of data included in the first data signal in parallel; and an electrical signal detector receiving the second data signal transmitted in the low power mode.

The optical signal detector may include: a photo diode converting the first data signal into a current signal; and an amplifier converting the current signal into a voltage signal having a logic level.

The de-serializer may include a clock data recovering circuit recovering a clock signal from the first data signal.

A swing level width of the first data signal may be smaller than that of the second data signal.

According to another aspect of the present invention, there is provided a method of operating a communications interface apparatus, including: generating a first data signal by serializing original data provided in parallel through a plurality of lanes and generating a second data signal from at least a part of the original data; transmitting the first data signal through a plastic optical fiber and transmitting the second data signal through a conductor line; and recovering the original data by receiving the first data signal and the second data signal, wherein at least one of a level and a frequency of the first data signal and the second data signal is different from each other.

In the generating of the signals, the first data signal may be generated from data of an image displayed by a display device and the second data signal may be generated from at least one of a power signal of the display device and a sensing signal of a touch screen panel provided in the display device.

In the generating of the signals, the first data signal and the second data signal maybe generated so that a swing level width of the first data signal has a larger value than that of the second data signal.

In the transmitting, the first data signal may be transmitted in a high speed mode and the second data signal may be transmitted in a low power mode.

The second data signal may include a control code for starting an operation to receive the first data signal in the high speed mode.

The recovering may include: generating clock data from the first data signal; generating the original data from the first data signal; and de-multiplexing the original data in each of the plurality of lanes connected to one another in parallel based on the clock data.

The generating of the original data may include: converting the first data signal into a current signal; generating a voltage signal having a logic level from the current signal; and generating the original data by de-serializing the voltage signal.

The transmitting may include: filtering the original data; and generating the first data signal by serializing the filtered original data.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram showing a mobile device to which a communications interface apparatus is provided in accordance with an embodiment of the present invention;

FIG. 2 is a block diagram schematically showing the communications interface apparatus provided in accordance with the embodiment of the present invention;

FIG. 3 is a block diagram showing a structure of a signal transmitting unit of the communications interface apparatus provided in accordance with the embodiment of the present invention;

FIG. 4 is a block diagram showing a structure of a signal receiving unit of the communications interface apparatus provided in accordance with the embodiment of the present invention;

FIG. 5 is a flow chart for describing a method of operating the communications interface apparatus provided in accordance with the embodiment of the present invention; and

FIG. 6 is a graph for describing data signals transmitted and received by the communications interface apparatus provided in accordance with the embodiment of the present invention.

### DETAILED DESCRIPTION OF THE EMBODIMENTS

Embodiments of the present invention will hereinafter be described in detail with reference to the accompanying drawings. These embodiments will be described in detail in order to allow those skilled in the art to practice the present invention. It should be appreciated that various embodiments of the present invention are different but do not have to be exclusive. For example, specific shapes, configurations, and characteristics described in an embodiment of the present invention may be implemented in another embodiment without departing from the spirit and the scope of the present invention. In addition, it should be understood that position and arrangement of individual components in each disclosed embodiment may be changed without departing from the spirit and the scope of the present invention. Therefore, a detailed description described below should not be construed as being restrictive. In addition, the scope of the present invention is defined only by the accompanying claims and their equivalents if appropriate. Similar reference numerals will be used to describe the same or similar functions throughout the accompanying drawing.

Hereinafter, embodiments of the present invention will be described in detail with reference to the accompanying drawings so that those skilled in the art may easily practice the present invention.

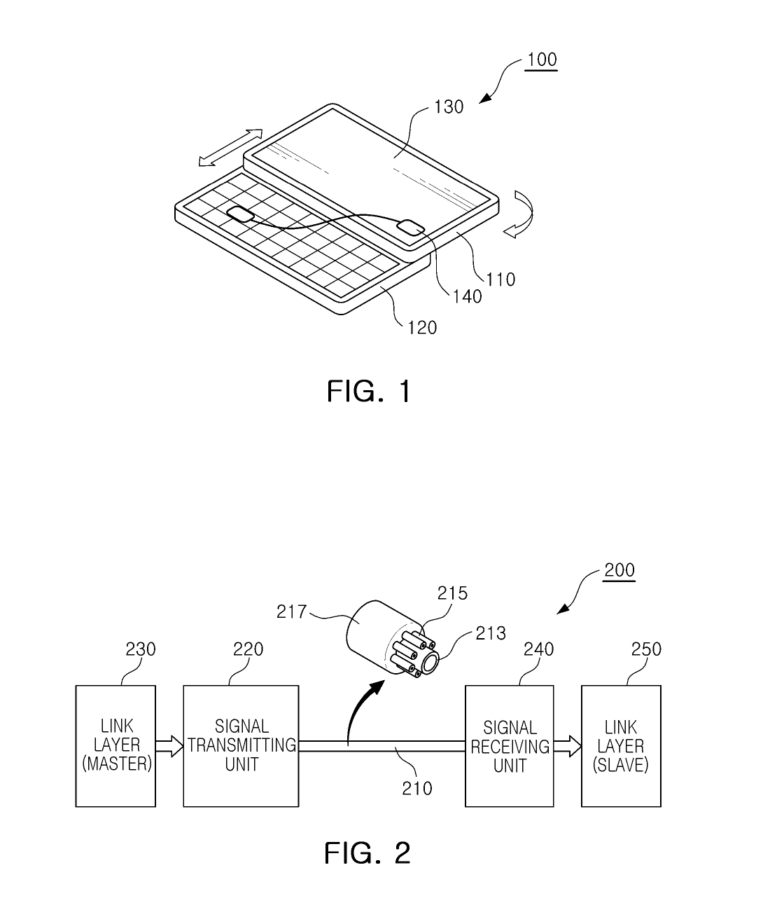

FIG. 1 is a diagram showing a mobile device to which a communications interface apparatus is provided in accordance with an embodiment of the present invention.

Referring to FIG. 1, a mobile device 100 in accordance with an embodiment of the present invention may include a first housing 110, a second housing 120, a display device 130 provided in the first housing 110, and a communications interface apparatus 140 that communicably connects the display device 130 to a central processing unit (CPU) of the mobile device 100. The communications interface apparatus 140 may relay communications between a driving circuit of the display device 130, a touch screen device attached to the display device 130, or the like, and the central processing unit of the mobile device 100.

When the display device 130 communicates with the central processing unit of the mobile device 100 by using a general flexible printed circuit board (FPCB) on which conductive patterns formed of a metal such as copper (Cu), or the like, are formed, it may be difficult to apply the display device 130 rotating or tilted in several directions due to a restriction of a design. Further, a plurality of flexible printed circuit boards are required to transmit a power signal, a data signal, a control signal, or the like, for the display device 130 and the touch screen device, and as a result, design complexity may be increased, signal loss may occur, and problems such as electromagnetic interference (EMI), or the like, in response to the increased transmission path due to the characteristics of the conductive pattern may also occur.

Therefore, as the transmission line of the communications interface apparatus 140 according to the embodiment of the present invention, a hybrid plastic of fiber (POF) using both of the optical cable line and the conductor line formed of a metal such as copper (Cu), or the like, may be applied. In this case, the high-capacity image data, or the like, displayed by the display device 130 is transmitted through the optical cable line which can implement fast data transmission, and a touch sensing data, a power signal, or the like, generated from the touch screen device may be transmitted through the conductor line having a slow speed but small power consumption.

FIG. 2 is a block diagram schematically showing the communications interface apparatus in accordance with the embodiment of the present invention.

Referring to FIG. 2, a communications interface apparatus 200 in accordance with an embodiment of the present invention may include a transmission line 210, a signal transmitting unit 220, a first circuit unit 230 providing a piece of data to be transmitted to the signal transmitting unit 220, a signal receiving unit 240 receiving and recovering a signal through the transmission line 210 to generate data, and a second circuit unit 250 processing the data generated by the signal receiving unit 240. Each of the first circuit unit 230 and the second circuit unit 250 may be operated according to a master/slave relationship.

As described above, the transmission line 210 may include a plastic optical fiber (POF) 213 and a conductor line 215. For example, in the transmission line 210 having a cylindrical cross section, the plastic optical fiber 213 may be disposed in a center thereof and a plurality of conductor lines 215 may be disposed at a circumference thereof. The conductor lines 215 are surrounded by an outer jacket 217 to protect against external impacts, the introduction of dust, or the like.

The signal transmitting unit 220 receives a piece of data to be transmitted from the first circuit unit 230 and transmits the data through the transmission line 210. For example, the signal transmitting unit 220 may serialize an amount of portion of original data received from the first circuit unit 230 to generate a first data signal transmitted through the plastic optical fiber 213. Part of the original data received from the first circuit unit 230 maybe separately processed as a second data signal transmitted through the conductor line 215. In order to generate the first data signal transmitted through the plastic optical fiber 213, the signal transmitting unit 220 may include a serializer. That is, the original data provided in parallel by the first circuit unit 230 may be serialized by a serializer and be converted into the first data signal appropriate for optical communications.

The signal receiving unit 240 may de-serialize the first data signal serialized by the signal transmitting unit 220 and transmitted through the plastic optical fiber 213 to recover the original data and may provide the original data to the second circuit unit 250 in parallel. The second data signal which may be separately processed rather than being serialized by the signal transmitting unit 220 is received through the conductor line 215 and is transmitted to the second circuit unit 250. For the signal processing and data recovering operation as described above, the signal receiving unit 240 may include a de-serializer and a clock data recover (CDR) circuit for extracting a clock signal from the first data signal.

The first data signal transmitted through the plastic optical fiber 213 and the second data signal transmitted through the conductor line 215 may have different values in terms of at least one of a level and a frequency. The plastic optical fiber 213 consumes a large amount of power in transmitting a piece of data at a higher speed than the conductor line 215. The conductor line 215 cannot easily implement the high-speed data transmission, but has low power consumption. Therefore, a balance between the power consumption and the signal transmission rates may be controlled by generating the first data signal from the high-capacity data of image displayed by the display device 130 and generating the second data signal from the power signal, the sensing data of the touch screen device, or the like.

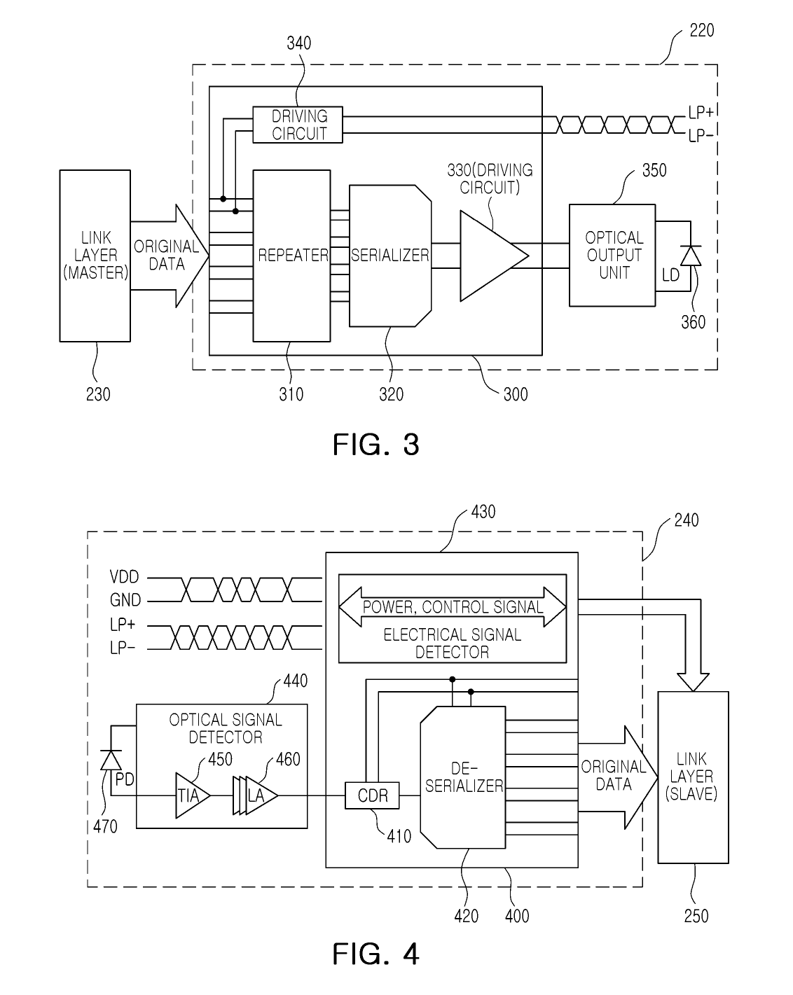

FIG. 3 is a block diagram showing a structure of a signal transmitting unit of the communications interface apparatus in accordance with the embodiment of the present invention.

Referring to FIG. 3, the signal transmitting unit 220 of the communications interface apparatus 200 in accordance with the embodiment of the present invention is connected to the first circuit unit 230 operated as the master to receive the original data and may include a signal converting unit 300 and an optical output unit 350. The signal converting unit 300 may include a repeater 310, a serializer 320, a driving circuit unit 330, a converter 340, and the like, and the optical output unit 350 is connected to a laser diode. (LD) 360 that transmits the signal through the plastic optical fiber 213.

The first circuit unit 230 provides the original data to the signal converting unit 300 in parallel communications. The original data provided in parallel is amplified by the repeater 310 and the serializer 320 may serialize the amplified original data to convert the serialized original data into the first data signal that maybe transmitted to the single plastic optical fiber 213. In FIG. 3, it is assumed that the original data is received in parallel from the first circuit unit 230 through a total of four lanes. Here, the serializer 320 converts a reference clock of one lane into a four times faster clock and the converted clock is included in the first data signal. The driving circuit unit 330 transmits the serialized first data signal to the optical output unit 350, wherein the first data signal is output through the laser diode (LD) 360 connected to the optical output unit 350 in a optical communications manner. The first data signal is transmitted in a high speed (HP) mode through the plastic optical fiber 213.

The converter 340 included in the signal converting unit 300 may use at least a part of the original data to generate the second data signal transmitted through the conductor line 215 in a low power (LP) mode. The second data signal may include the data transmitted through the conductor line 215 at low power and low speed. For example, the second data signal may include the power signal of the display device 130, the touch screen device, or the like, the sensing data of the touch screen device, or the like.

In addition, for efficiency of power management, the second data signal transmitted in the low power mode may include information that may indicate whether the detection operation of the first data signal transmitted in the high speed mode starts. For example, as shown in FIG. 3, it is assumed that the second data signal is transmitted at LP+ and LP− having VDD digitally corresponding to 1 and a voltage level value of GND digitally corresponding to 0, respectively. In this case, the signal transmitting unit 220 may transmit the second data signal in which a combined code of LP+ and LP− is consecutively changed from [11] to [00] via [01] so that the signal receiving unit 240 receives the first data signal transmitted in a high speed mode to recover the original data. This will be described with reference to FIG. 6.

FIG. 4 is a block diagram showing a structure of a signal receiving unit of the communications interface apparatus in accordance with the embodiment of the present invention.

Referring to FIG. 4, the signal receiving unit 240 of the communications interface apparatus 200 in accordance with the embodiment of the present invention may include an optical signal detector 440 and a signal recovery unit 400. The optical signal detector 440 detects the first data signal transmitted in the high speed mode by a photo diode (PD) 470. The photo diode 470 converts the first data signal transmitted as the optical signal through the plastic optical fiber 213 into a current signal, wherein the current signal is converted into a voltage signal having a predetermined logic level by a trans impedance amplifier (TIA) 450 and a limit amplifier (LA) 460.

The voltage signal output by the optical signal detector 440 is transmitted to the signal recovery unit 400. The signal recovery unit 400 may include a clock data recovery circuit 410, a de-serializer 420, and electrical signal detector 430. The clock data recovery circuit 410 recovers the clock data from the voltage signal output by the optical signal detector 440. In FIG. 3, it is assumed that the original data is input in parallel through a total of four lanes. In this case, it is described that the clock signal of one lane is converted into a four times faster clock signal and is transmitted. The clock data recovery circuit recovers the four times faster converted clock signal to an original clock signal and the recovered clock signal is transmitted to the de-serializer 420. In this case, the de-serializer 420 may be used to again de-multiplex the original data included in the first data signal in four lanes.

The electrical signal detector 430 receives the second data signal transmitted through the conductor line 215 in the low power mode and detects the power signal, the control signal, or the like, therefrom. The control signal may include the information regarding an operation switching timing that receives and processes the first data signal transmitted in the high speed mode by the signal receiving mode 240. For example, as described above, when the digital logic values of LP+ and LP− are consecutively changed from [11] to [00] via [01], the operation mode of the signal receiving unit 240 maybe switched to the high speed mode that receives and processes the first data signal. In addition, the electrical signal detector 430 may detect an instruction language necessary to recover the image data, or the like, from the second data signal.

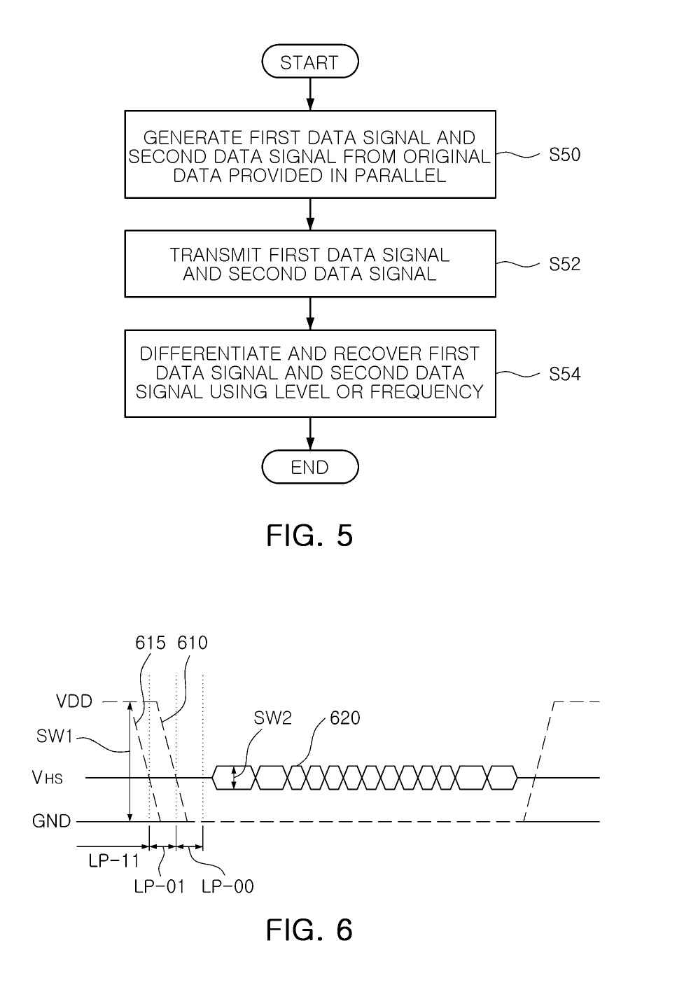

FIG. 5 is a flow chart for describing a method of operating the communications interface apparatus in accordance with an embodiment of the present invention.

Referring to FIG. 5, the method of operating the communications interface apparatus in accordance with the embodiment of the present invention starts to generate a first data signal and a second data signal from original data provided in parallel (S50). When receiving the original data in parallel from the first circuit unit 230 operated as a master, the signal transmitting unit 220 serializes at least a part of the original data to generate the first data signal transmitted to the plastic optical fiber 213 through the optical output unit 350. In addition, the converter 340 included in the signal transmitting unit 220 may generate the second data signal transmitted to the conductor line 215 from a part of the original data. The first data signal may include a large-capacity image, image data, or the like, as a signal transmitted in the high speed mode, and the second data may include the power signal, a control signal indicating the high speed operation switching of the signal receiving unit 240, sensing data of the touch screen device, or the like, as a signal transmitted in the low speed mode.

The first data signal and the second data signal generated in S50 are transmitted to the signal receiving unit 240 through the plastic optical fiber 213 and the conductor line 215 (S52). The first data signal transmitted in the high speed mode through the plastic optical fiber 213 is a data signal generated by serializing the original data provided in parallel through the plurality of lanes, such that the signal receiving unit 240 also needs to be operated in the high speed mode so as to allow the signal receiving unit 240 to recover the original data from the first data signal. Therefore, whether the signal receiving unit 240 is operated in the high speed mode and information for clock synchronization in the high speed mode may be transmitted by being included in the second data signal. This will be described in detail with reference to FIG. 6.

FIG. 6 is a graph for describing data signals transmitted and received by the communications interface apparatus in accordance with the embodiment of the present invention. FIG. 6 illustrates second data signals 610 and 615 transmitted in the low power mode and a first data signal 620 transmitted in the high speed mode. The first data signal 620 and the second data signals 610 and 615 respectively have voltage levels SW2 and SW1 and reference numerals 610 and 615 in the second data signals respectively represent the LP− and LP+.

Describing the change in the second data signals 610 and 615 transmitted in the low power mode, both values of the LP+ and the LP− are changed to LP−01 in which the LP+ has GND corresponding to the digital logic value 0, from LP−11 that is a state having VDD corresponding to a digital logic value 1. Next, when the value of the LP− is also changed to the GND and thus, the state of the second data signal reaches LP-00, the signal receiving unit 240 is switched to the high speed mode to prepare to receive and recover the first data signal 620. That is, when detecting that a combination of the digital logic values of the LP+ 615 and the LP− 610 transmitted by being included in the second data signals 610 and 615 is changed from [11] to [00] via [01], the signal receiving unit 240 may be operated in the high speed mode.

Referring to FIG. 6, the first data signal 620 and the second data signals 610 and 615 have different voltage level swing widths SW2 and SW1. Therefore, the signal receiving unit 240 may differentiate the first data signal 620 and the second data signals 610 and 615 based on the level of the received signal. In addition, the first data signal 620 and the second data signals 610 and 615 have different frequencies and therefore, the first data signal 620 and the second data signals 610 and 615 may also be differentiated based on the frequency.

When the first data signal 620 and the second data signals 610 and 615 are transmitted, as described with reference to FIG. 6, the first data signal 620 and the second data signals 610 and 615 are differentiated using the level or the frequency, and the original data is recovered (S54). The optical signal detector 440 included in the signal receiving unit 240 receives the first data signal, and the signal converter 400 may transmit the original data recovered through the signal processing processes such as de-serializing the first data signal, extracting the clock signal, or the like to the second circuit unit 250 operated as the slave.

The communications interface apparatus and the method of operating the same described with reference to FIGS. 1 to may be representatively applied to the communications according to the Mobile Industry Processor Interface (MIPI) standard but is not necessarily limited thereto. In addition, for convenience of explanation, communications between the central processing unit of the mobile device 100 and the display device 130 are described by way of example, but various embodiments of the present invention may be applied between the plurality of signal processing apparatuses operated depending on the master and the slave relationship.

As set forth above, according to embodiments of the present invention, in the communications interface apparatus and the method of operating the same between the display device and the central processing unit, data signals having different levels or frequencies may be transmitted and received through the transmission line including the plastic optical fiber and the conductor line. Therefore, signal loss may be reduced by transmitting and receiving the high-capacity data through the plastic optical fiber at a relatively high speed, and more various types of hardware design structures than the case of using the general FPCB may be provided.

While the present invention has been shown and described in connection with the embodiments, it will be apparent to those skilled in the art that modifications and variations can be made without departing from the spirit and scope of the invention as defined by the appended claims.

What is claimed is:

1. A communications interface apparatus, comprising:
a transmission line including a conductor line and a plastic optical fiber for optical communications;
a signal transmitting unit transmitting a first data signal through the plastic optical fiber and transmitting a second data signal through the conductor line; and
a signal receiving unit receiving the first data signal and the second data signal,
the signal transmitting unit differentiating a signal as the first data signal or the second data signal based on at least one of a level and a frequency of the signal to be transmitted.

2. The communications interface apparatus of claim 1, wherein the signal transmitting unit includes:
a signal converting unit generating the first data signal by serializing original data provided in parallel and generating the second data signal transmitted in a low power mode from part of the data provided in parallel; and
an optical output unit outputting the first data signal to the plastic optical fiber.

3. The communications interface apparatus of claim 2, wherein the signal converting unit includes:
a repeater block filtering the original data;
a serializer serializing an output of the repeater block; and
a driving circuit unit generating the first data signal transmitted in a high speed mode from an output of the serializer.

4. The communications interface apparatus of claim 1, wherein the signal receiving unit includes:
an optical signal detector receiving the first data signal from the plastic optical fiber;
a de-serializer de-serializing the first data signal to realign a plurality of pieces of data included in the first data signal in parallel; and
an electrical signal detector receiving the second data signal transmitted in the low power mode.

5. The communications interface apparatus of claim 4, wherein the optical signal detector includes:
a photo diode converting the first data signal into a current signal; and
an amplifier converting the current signal into a voltage signal having a logic level.

6. The communications interface apparatus of claim 4, wherein the de-serializer includes a clock data recovering circuit recovering a clock signal from the first data signal.

7. The communications interface apparatus of claim 1, wherein a swing level width of the first data signal is smaller than that of the second data signal.

8. A method of operating a communications interface apparatus, comprising:
generating a first data signal by serializing original data provided in parallel through a plurality of lanes and generating a second data signal from at least a part of the original data;
transmitting the first data signal through a plastic optical fiber and transmitting the second data signal through a conductor line; and
recovering the original data by receiving the first data signal and the second data signal,
at least one of a level and a frequency of the first data signal and the second data signal being different from each other.

9. The method of claim 8, wherein in the generating of the signals, the first data signal is generated from data of image displayed by a display device and the second data signal is generated from at least one of a power signal of the display device and a sensing signal of a touch screen panel provided in the display device.

10. The method of claim 8, wherein in the generating of the signals, the first data signal and the second data signal are generated so that a swing level width of the first data signal has a larger value than that of the second data signal.

11. The method of claim 8, wherein in the transmitting, the first data signal is transmitted in a high speed mode and the second data signal is transmitted in a low power mode.

12. The method of claim 11, wherein the second data signal includes a control code for starting an operation to receive the first data signal in the high speed mode.

13. The method of claim 8, wherein the recovering includes:
generating clock data from the first data signal;
generating the original data from the first data signal; and
de-multiplexing the original data in each of the plurality of lanes connected to one another in parallel, based on the clock data.

14. The method of claim 13, wherein the generating of the original data includes:
converting the first data signal into a current signal;
generating a voltage signal having a logic level from the current signal; and
generating the original data by de-serializing the voltage signal.

15. The method of claim 8, wherein the transmitting includes:
filtering the original data; and
generating the first data signal by serializing the filtered original data.
